(19) United States
(12) Patent Application Publication
(10) Pub. No.: US 2003/0225890 A1
(43) Pub. Date: Dec. 4, 2003

(54) State token for thin client devices

(76) Inventors: Robert A. Dunstan, Forest Grove, OR (US); Ylian Saint-Hilaire, Hillsboro, OR (US)

Correspondence Address: KENYON & KENYON, 1500 K STREET, N.W., SUITE 700, WASHINGTON, DC, 20005, US

(21) Appl. No.: 10/158,907

(22) Filed: Jun. 3, 2002

(51) Int. Cl. G06F 15/173; G06F 15/16

(52) U.S. Cl. 709/227; 709/232

(57) ABSTRACT

In an extended application network, where a server may execute applications on behalf of a user at a “dumb” client device, operation continuity is maintained through use of a state token. The server periodically provides to the client device one or more “state tokens,” which are stored at the client device. If, at some later time, the client device is commanded by the same or another server to furnish the state token, the stateless device does so. Typically, such commands will be received when communication between the client and the first server is lost due to equipment malfunction or other cause. The state token permits the second server to identify an application that had been executing on behalf of the thin client device and to resume its execution at the point where the first server left off.

### BACKGROUND

Embodiments of the present invention provide a technique for maintaining performance continuity among “thin client devices” in a computer network.

A thin client device is a processor or computer platform that, for whatever reason, is provided with reduced processing ability. Such thin client devices are foreseen for use in residential and other computer networks where computer controls may be provided for each of a number of appliances within the home. For example, digital picture frames, remote displays, vehicular heads-up displays, wireless control panels, remote controls, televisions, video displays, audio players, home appliances and the like need not be provided with immense computing ability. Instead, it may be sufficient to provide one or a limited number of powerful computer servers, personal computers or the like (collectively, “servers”) that define operation of each thin client.

The thin client device may be provisioned with a central processing unit, some memory and/or input/output devices. Others may include digital signal processors or application specific integrated circuits (ASICs) either in addition to or in lieu of a central processing unit. Typically, however, thin clients do not execute application-level software. The thin client device executes program instructions to be sure, but they resemble application program interfaces (APIs) from conventional computer operating systems rather than higher-level applications. The client-side instructions manage low-level operations such as capturing user input through depression of hardware buttons or contact on a touch screen. The client-side instructions also may manage the output of data. For example, the thin client device may include sufficient programming and processing ability to decode compressed video or audio data and to render the data via a display or speakers. The thin client, however, does not determine what to display and does not interpret user input. It relays user input to the server and it takes only those actions that are commanded by an application executing on the server. Thus, the thin client is analogous to a user interface device. The client has no “knowledge” of the application's state and, therefore, operates as a stateless device. Application processing is performed elsewhere at the server.

Although not universally true, some thin client devices are general purpose computer platforms; others have special purpose hardware tailored for specific applications. The functionality of the general purpose clients may be determined entirely by the applications that execute on the server. For example, if the server executes a calendar application on behalf of the client device, the client operates as a personal calendar. The server may execute other applications on behalf of the same thin client device at other times, causing the client to operate as some other kind of device (such as a picture frame, outputting still image data). These applications define different “logical devices” that may operate through a common hardware platform. In this regard, the operation of the thin client device is well known.

Because the thin client device depends upon applications executing on a server, it is vulnerable to failures that may occur at the server or in the communication links that carry commands to the client device. For example, in a wireless network, a portable thin client device may wander out of communication range for a time and later wander back into range. In a multiple server network, it is possible that a second server would be available to assume execution of an application previously being executed on behalf of a thin client if communication between an original server and the thin client were lost. In current networks, however there is no known technique that would permit the second server to determine the prior state of an application being executed elsewhere on behalf of the thin client. The thin client device, when it loses communication with the original server, will not be able to continue progress with any application executing on that server.

Most often, when the thin client loses contact with its original server, the thin client ceases to respond to user input and fails to generate outputs that would be characteristic of proper application execution. An operator at the client device would be forced to restart the application when the thin client re-establishes communication with a server, whether it be its original server or some other second server. Any prior progress made with the original server would be lost and the user would have to duplicate it when the application is restarted.

It is expected that such consumer experiences would be detrimental to the commercial success of a distributed network populated by thin client devices. Consumers do not know of the network conditions that exist between thin clients and their controlling servers and, more importantly, they do not care. They do not care whether an application executes on a client or a server. Consumers expect that executing applications be immune from such network failures, particularly if failover capacity is available in secondary server controls.

Accordingly, there is a need in the art for a computer control system that permits thin clients to maintain access to server-side applications even in the presence of equipment failure at a controlling server or in communication fabric between the client and the server. There is a need in the art, when constant communication between a thin client and a server cannot be maintained, for an application management scheme that permits a thin client to resume operation in application when communication is restored at a point of progress that had been reached when communication failed.

### BRIEF DESCRIPTION OF THE DRAWINGS

FIG. 1 is a block diagram of a computer network according to an embodiment of the present invention.

FIG. 2 is a flow diagram illustrating use of the state token according to embodiments of the present invention.

FIG. 3 illustrates a method operable at a server according to an embodiment of the present invention.

FIG. 4 is a block diagram of another computer network according to an embodiment of the present invention.

### DETAILED DESCRIPTION

Embodiments of the present invention provide a technique for maintaining operating continuity at a thin client device when communication between the client device and a server is lost. According to these embodiments, the server provides to the stateless thin client device one or more “state tokens,” which are stored. The state token identifies an operating state of an application for the thin client device being executed on the server. Following the loss of communication between the thin client device and the original server, if the client device regains communication with some server (either the original or a new server), then this client may be commanded to furnish the state token. It does so. This permits the communicating server to identify an application that had been executing on behalf of the thin client device and provides sufficient state information to the server to resume its execution where it left off.

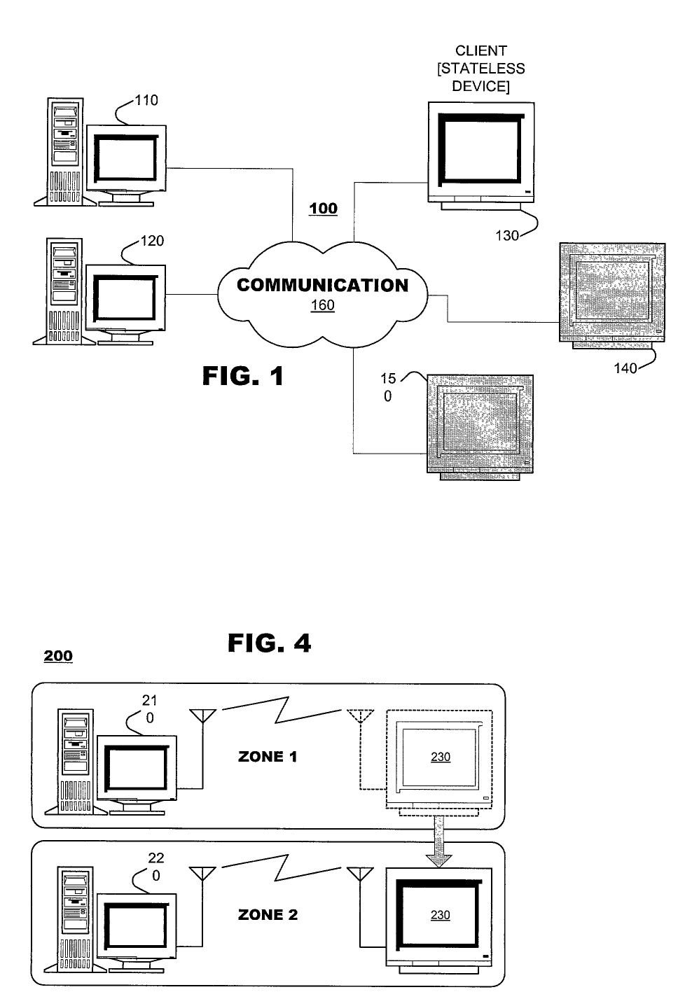

FIG. 1 is a block diagram of a computer network 100 according to an embodiment of the present invention. The network is shown as populated by a pair of servers 110, 120 and thin client devices 130, 140, 150. The network elements 110-150 may communicate with each other by a communication network 160, which may be a telecommunication network, a wired computer network (such as a LAN, an intranet or Internet) a wireless communication network involving radio-frequency or infra-red communication links, or a hybrid of these networks.

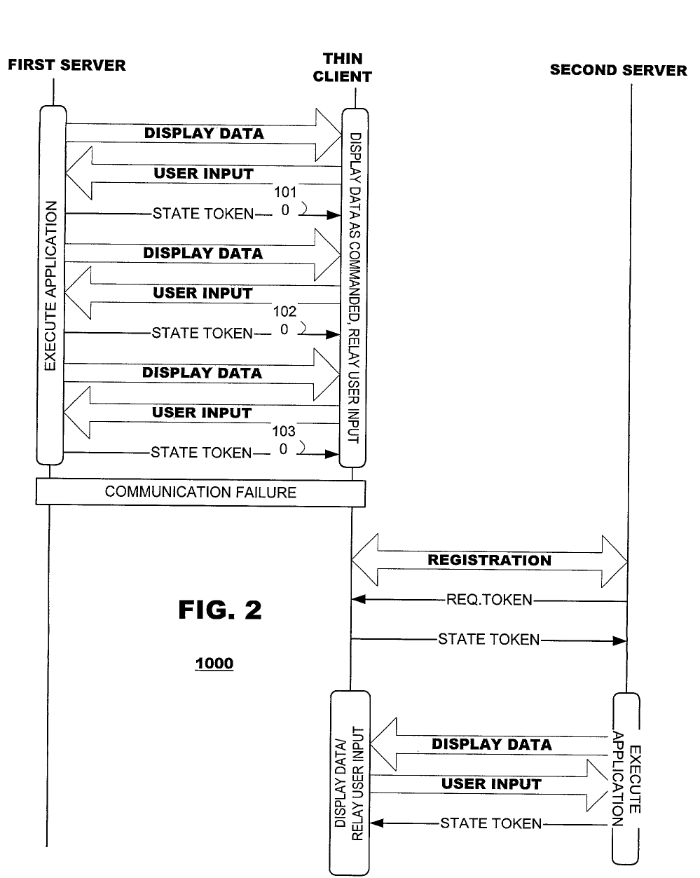

FIG. 2 is a flow diagram illustrating use of the state token according to embodiments of the present invention. Initially, a first server (say, server 110 of FIG. 1) executes an application on behalf of the thin client 130. In accordance with requirements set by the application, the server 110 transfers display data (audio, visual) to the thin client 130. The thin client 130 also captures user input and relays it to the server 110. These operations continue throughout the progress of the application.

The first server captures state information associated with the application. Such state information is a ‘snapshot’ of progress made by the application and a position in program flow. Such state information may identify, for example, an identifier of an application being executed on behalf of the thin client device, an owner of the application (identifying the server that is executing the application), a time stamp of the token, and application state information. The first server transmits the state token to the thin client and instructs it to store the token locally. Transmissions 1000, 1010 and 1020 are illustrated in FIG. 2. When new state tokens are transmitted to the thin client, they may overwrite other state tokens previously stored.

At some point, the thin client 130 may lose communication with the first server 110 and may become registered with a new server (say, server 120 from FIG. 1). In this event, the new server 120 may request a copy of the state token stored by the thin client 130 (transmission 1030). The thin client 130 transmits the state token to the new server 120 as requested (transmission 1040). Upon receipt of the state token, the new server 120 may resume execution of the application identified by the state token at a position identified from the token. Thereafter, the new server 120 may exchange display data and user input data with the thin client 130 and may provide additional state tokens for storage at the thin client 130 (transmission 1050).

The foregoing operation also finds application in a situation where a thin client loses communication with a server 110 but subsequently regains communication with the server 110. In this event, the first server 110 may act as the “new” server as disclosed in FIG. 2. Indeed, the operation of FIG. 2 may integrate into any embodiment where a server auto-detects new thin client devices.

The timetable for generation of state tokens may occur in a variety of different ways. In a first embodiment, state tokens may be generated at regular times during execution of the application, for example every thirty minutes or every five minutes, depending upon the application being executed. Such a scheme would guarantee that duplicative execution would be limited to a predetermined minimum. Because the token would be current within a time interval defined by the update period. In another embodiment, the generation of state tokens may be integrated with the software structure of the application being executed. Tokens may be generated at significant stages of execution and transmitted to the thin client device 130. In this latter embodiment, it is possible to protect against loss of significant data during execution of an application by updating the state token at these significant stages of execution. Other schemes are possible.

As discussed, the state tokens provide information on the progress of an application at a particular server. As such, the structure of such tokens and the information contained therein will vary based upon the application being executed. Some common information may include an application ID field identifying the application being executed and an ID/address of the server currently executing the application on behalf of the client device. Some examples of token structure and syntax follow:

TABLE 1
Token Structure: <Device ID>/<Device Specific State>
Example No. 1

| | |
|---|---|
| Device ID: | Intel Picture Frame |
| Device Specific State: | Last Host, 172.16.0.34. |

Example No. 2

| | |
|---|---|
| Device ID: | Movie Projector |
| Device Specific State: | Tuner1 = 0,0,1024,780, TTV7, R34, G68, B50 |
| | Tuner2 = 0,0,320,240, V1 |

Table 1 illustrates an exemplary token structure according to an embodiment of the present invention. In this example, a token contains a Device ID field that identifies the device type of the thin client. The Device Specific State field contains information specific to its operating state. The type of information to be carried in the Device Specific State field can vary. Two examples are illustrated above. In first the example, the Device ID identifies the application to be “Intel Picture Frame.” The Device Specific State field identifies the last server to host an application on the thin client's behalf. The Device Specific State field, therefore includes a “last host” identifier code and an identifier of the host server, shown as an address above.

In the second example, the Device ID identifies the application to be “Movie Projector.” The Device Specific State is shown as having two fields, each related to a respective “tuner.” This example is foreseen for use in a video playback application having picture-in-picture functionality. The tuner fields illustrate positions and sizes of relative playback windows. In the example illustrated above, both windows have an origin at coordinates 0,0. The first tuner window has a size of 1024×780 pixels, accepts a video source from terrestrial TV channel 7 and renders a video output using color intensity levels of red=34%, green=68% and blue=50%. The second tuner window has a size of 320×240 pixels and accepts a video source from an input labeled V1 (perhaps an external video input source). No color intensity levels are specified in the second token, which may permit default values to be used (such as 50% for each color component). Of course, there is an almost limitless range of information that may be represented by the Device Specific State field. The range of different items to be store will depend most strongly on the configuration and capabilities of the thin client itself.

TABLE 2
Token Structure: <Application ID>/<Application State>
Example

| | |
|---|---|
| Application ID: | Picture Frame Pro |
| Application State: | Screen = 5, Picture = 45 |

Table 2 illustrates another exemplary token structure. This time, instead of identifying the type of thin client device, the token identifies an application executing on the host server and the state of the application. In this example, the token includes a code identifying an application called “Picture Frame Pro” and indicates a most recently presented screen and picture.

TABLE 3
Token Structure: <Application ID>/<Application Version>/
<Application State>
Example

| | |
|---|---|
| Application ID: | Picture Frame Pro |
| Application Version | 1.0 |
| Application State: | Screen = 5, Picture = 45 |

Table 3 illustrates another exemplary token structure according to an embodiment of the present invention. In this example, the token identifies an executing application and the application's state in a manner similar to the example shown in Table 2. Additionally, the token identifies a version of the application by an appropriate code in an Application Version field. The versions identified can be specific, such as 1.0, or they can identify a range of versions in a manner analogous to “1.*” in some popular software protocols (e.g., MS DOS, Microsoft Windows). Appropriate codes can be designated for both types of identifiers.

TABLE 4
Token Structure: <BootLoader ID>/<Application ID>/
<Application State>
Example

| | |
|---|---|
| Bootloader ID: | 3459852034203 |
| Application ID: | Picture Frame Pro |
| Application State: | Screen = 5, Picture = 45 |

Table 4 provides an additional example of token structure. In this example, the token identifies a “bootloader” in addition to an application. The bootloader may identify a software platform for the server that defines an operation context in which an identified application operates. In this regard, the bootloader platform is analogous to conventional operating systems. When attempting to resume operation of an application, such as the “Picture Frame Pro” identified in the example of Table 4, the server first may identify, obtain and execute the software platform corresponding to the bootloader before executing the application itself. Table 4 is an example of a layered token, in which the token defines possibly many applications or software platforms that a server may execute to resume operation of an application on behalf of the thin client device. A layered token is one that is built progressively from a plurality of fields, each providing information that is more specific than a preceding field. Thus, in the foregoing example, the bootloader field provides the most generic information within the token and the application state is the most specific information in the token.

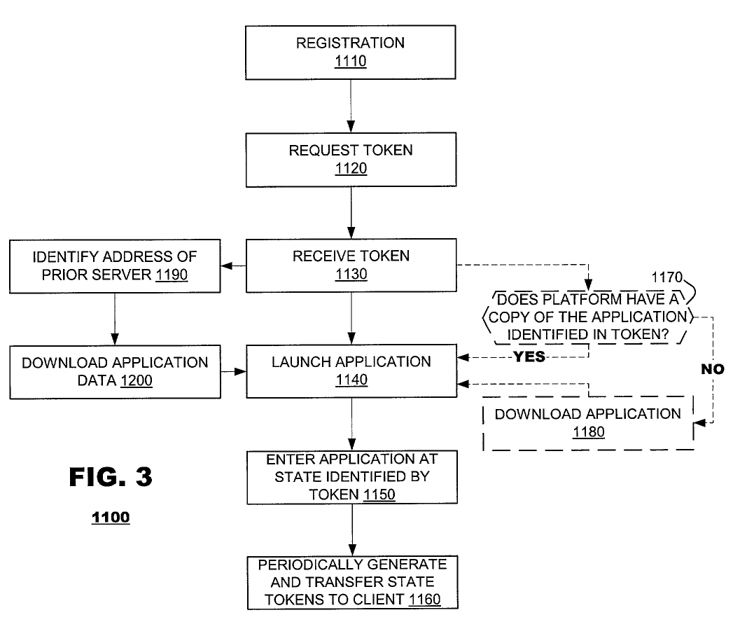

FIG. 3 illustrates a method 1100 operable at a server according to an embodiment of the present invention. When a client 130 registers with a new server, for example, the second server 120 of FIG. 1, the server 120 may request a token from the client 130 (blocks 1110-1120). The server 120 thereafter receives the token (block 1130) or an indication that no prior token has been stored. Upon receipt of the token, the server 120 may launch the application and resume execution of the application using state information provided in the token (blocks 1140-1150). Of course, during execution of the application, the second server may generate new state tokens periodically and transmit them to the client device 130 (block 1160).

In another embodiment, shown in phantom, after receiving the token the server 120 may determine whether it has a copy of the identified application stored locally (block 1170). If not, the server downloads the application from some network source and then launches it (blocks 1180, 1130). Of course, the state token can be modified to identify a network address where the application is stored.

In a further embodiment, also shown in phantom, when the token includes an address of a server that previously executed applications on behalf of the client 130 (e.g., the first server 110 of FIG. 1), the server 120 may attempt to communicate with the first server 110 to retrieve application data stored thereon (blocks 1190-1200). Such an embodiment provides improved performance by placing with the second server 120 additional information related to execution. This can improves the degree to which network failures are made transparent to the end user.

According to another embodiment of the present invention, a server (or plurality of servers) may execute multiple applications for a single client device. Just as present day operating systems permit computer users to open multiple applications and toggle through them at the users' discretion, such functionality may be extended to users at client devices. In such an embodiment, a server may transmit multiple state tokens to the client device, each identifying a respective application to which the token corresponds. In this embodiment, the client device 130 may store multiple tokens, one for each application that is “open” at a server.

The foregoing description have described the use of state tokens to guard against network failures, either at a server or within the communication fabric that interconnects the client device 130 with the server 110. Of course, application of these state tokens is not so limited. For example, they may find application in wireless networking applications where a portable client device is moved spatially. In such an embodiment, shown in FIG. 4, each of a plurality of servers 210, 220 may be assigned a zone of coverage. In such a network, each server may become responsible for executing applications for each client device within its respective zone. When a portable client device 230 moves from one zone to another (say, ZONE 1 to ZONE 2), state tokens may be used to transfer an executing application among the servers. Similarly, as noted, state tokens may be useful even in a single server environment when the same server that loses communication with a thin client, through communication or equipment failure at the server, the client or in the communication fabric therebetween, later re-establishes communication with the client. The server may examine the client's state token to determine the progress that had been made in execution at the thin client before the service disruption.

Note also that a single server may execute applications on behalf of several thin client devices concurrently. Thus, a server may perform the foregoing methods and operations multiple times in an independent fashion for possibly many thin client devices under its management and control.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A client device comprising a memory to store a state token, the state token identifying an application being executed by another device on behalf of the client device, the application defining operation of the client device.

2. The client device of claim 1, wherein the memory stores program instructions that, when executed, cause the client device to capture user input and relay the user input to the other device.

3. The client device of claim 1, further comprising a communication interface to receive the state token from the other device prior to the token being stored in the memory.

4. The client device of claim 1, wherein the state token includes identifies an address of the other device.

5. The client device of claim 1, wherein the state token identifies the application being executed.

6. The client device of claim 1, wherein the state token identifies a point in architecture of the application that had been reached as of a time the state token was created.

7. The client device of claim 1, wherein the state token is a layered token, identifying several sets of program instructions being executed on behalf of a thin client device, one set establishing a context for executing a second set.

8. The client device of claim 1, wherein the client device stores multiple tokens, each associated with a respective application being executed on behalf of the client device elsewhere in a computer network.

9. The client device of claim 1, wherein upon command the client device transmits the state token to an external device.

10. The client device of claim 1, wherein execution of program instructions at the client device never uses data from the state token.

11. The client device of claim 1, wherein the client device comprises a microprocessor.

12. The client device of claim 1, wherein the client device comprises an application specific integrated circuit.

13. The client device of claim 1, wherein the client device comprises a digital signal processor.

14. The client device of claim 1, wherein the client device comprises a non-volatile memory to store the state token.

15. A method of maintaining continuity in a computer network, comprising:
when a new client device is registered, receiving a state token from the client device,
launching an application identified by the state token, and
executing the application at an executing location identified by the state token.

16. The method of claim 15, further comprising:
communicating with another device identified by the state token, and
retrieving from the other device application data associated with the client device.

17. The method of claim 15, further comprising, following receipt of the token but before execution of the application:
determining whether a copy of the application is stored locally and
if not, retrieving a copy of the application.

18. A continuity method for a computer network, comprising, at a server device that executes an application on behalf of a client device, periodically transmitting to the client device a state token that identifies operating status of the application.

19. The continuity method of claim 18, wherein the transmitting occurs at regular timing intervals.

20. The continuity method of claim 18, wherein the transmitting occurs when progress of the application reaches predetermined points in program architecture of the application.

21. The continuity method of claim 18, further comprising receiving from the client device indicators of user inputs entered at the user device.

22. The continuity method of claim 18, further comprising controlling, by the server device, display of data at the client device.

23. The continuity method of claim 18, further comprising storing the state token in a memory at the client device.

24. The continuity method of claim 23, further comprising transmitting the state token from the client device to a second server.

25. The continuity method of claim 23, wherein the state token is stored in non-volatile memory.

26. The continuity method of claim 24, wherein the transmitting of the state token from the client device to a second server occurs upon registration of the client device with the second server.

27. The continuity method of claim 24, wherein the transmitting of the state token from the client device to a second server occurs upon receipt of a command from the second server.

28. A management method, comprising:
at a computer, executing applications on behalf of one or more thin client devices, each application establishing a logical device for a respective thin client device, and
at predetermined times, generating a state token representative of progress of the application and transferring the state token to the corresponding thin client device.

29. The management method of claim 28, wherein the predetermined times are defined by periodic time intervals.

30. The management method of claim 28, wherein the predetermined times are defined by an architecture of the respective application.

31. The management method of claim 28, further comprising, upon detection of a new thin client device, transferring a previously stored state token from the new device to the server and, at the server, executing an application identified by the state token.

32. The management method of claim 28, further comprising, upon detection of a new thin client device:
receiving a previously stored state token from the new device
identifying a server from the received state token, and
communicating with the identified server to obtain application information regarding the new thin client device.

33. A computer readable medium having stored thereon program instructions that, when executed, cause a thin client device to:
store a state token, the state token representing an execution state of an application being executed on another device on behalf of the thin client device,
render output data at the thin client, the output data being provided from the other device, and
capture input data at the thin client and relay the input data to the other device.

34. The medium of claim 33, wherein the state token includes identifies an address of the other device.

35. The medium of claim 33, wherein the state token identifies the application being executed.

36. The medium of claim 33, wherein the state token is a layered token, identifying several sets of program instructions being executed on behalf of a thin client device, one set establishing a context for executing a second set.

37. The medium of claim 33, wherein the instructions cause the client device to store multiple tokens, each associated with a respective application being executed on behalf of the client device elsewhere in a computer network.

38. The medium of claim 33, wherein the instructions cause the client device to transmit the state token to an external device upon command.
